(19) United States
(12) Patent Application Publication
(10) Pub. No.: US 2011/0027571 A1
(43) Pub. Date: Feb. 3, 2011

(54) HEAT RESISTANT POLYAMIDE COMPOSITE STRUCTURES AND PROCESSES FOR THEIR PREPARATION

(75) Inventors: Martyn Douglas Wakeman, Gland (CH); Olaf Norbert Kirchner, Genolier (CH); Shengmei Yuan, Newark, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. DU PONT DE NEMOURS AND COMPANY, Wilmington, DE (US)

(21) Appl. No.: 12/846,210

(22) Filed: Jul. 29, 2010

Related U.S. Application Data
(60) Provisional application No. 61/229,777, filed on Jul. 30, 2009.

(51) Int. Cl. B29C 70/02

(52) U.S. Cl. 428/293.4; 264/165

(57) ABSTRACT

The invention relates to the field of composite structures comprising a fibrous material, a matrix resin composition and a portion made of a surface resin composition, wherein the compositions are chosen from compositions comprising one or more fully aliphatic polyamides and one or more polyhydric alcohols.

### CROSS REFERENCE TO RELATED APPLICATIONS

This application claims the benefit of U.S. Provisional Application No. 61/229,777, filed Jul. 30, 2009, now pending, the entire disclosure of which is incorporated herein by reference.

### FIELD OF THE INVENTION

The present invention relates to the field of composite structures and processes for making them, particularly it relates to the field of heat resistant polyamide composite structures.

### BACKGROUND OF THE INVENTION

With the aim of replacing metal parts for weight saving and cost reduction while having comparable or superior mechanical performance, structures based on composite materials comprising a polymer matrix containing a fibrous material have been developed. With this growing interest, fiber reinforced plastic composite structures have been designed because of their excellent physical properties resulting from the combination of the fibrous material and the polymer matrix and are used in various end-use applications. Manufacturing techniques have been developed for improving the impregnation of the fibrous material with a polymer matrix to optimize the properties of the composite structure. In highly demanding applications, such as for example structural parts in automotive and aerospace applications, composite materials are desired due to a unique combination of light weight, high strength and temperature resistance.

High performance composite structures can be obtained using thermosetting resins or thermoplastic resins as the polymer matrix. Thermoplastic-based composite structures present several advantages over thermoset-based composite structures such as, for example, the fact that they can be post-formed or reprocessed by the application of heat and pressure; a reduced time is needed to make the composite structures because no curing step is required; and they have increased potential for recycling. Indeed, the time consuming chemical reaction of cross-linking for thermosetting resins (curing) is not required during the processing of thermoplastics.

Among thermoplastic resins, polyamide resins are particularly well suited for manufacturing composite structures. Thermoplastic polyamide compositions are desirable for use in a wide range of applications including parts used in automobiles, electrical/electronic parts, household appliances and furniture because of their good mechanical properties, heat resistance, impact resistance and chemical resistance and because they may be conveniently and flexibly molded into a variety of articles of varying degrees of complexity and intricacy.

U.S. Pat. No. 4,255,219 discloses a thermoplastic sheet material useful in forming composites. The disclosed thermoplastic sheet material is made of polyamide 6 and a dibasic carboxylic acid or anhydride or esters thereof and is formed into a composite by layering the sheet with at least one reinforcing mat of long glass fibers and heating under pressure. However, composites made from polyamide 6 may show a loss of their mechanical properties over a typical end-use application temperature range, such as for example from −40° C. to +120° C.

With the aim of improving the manufacture of composite structures and allowing an easier, shorter and uniform impregnation of the fibrous material, several ways have been developed to decrease the melt viscosity of the polymer matrix. By having a melt viscosity as low as possible, polymer compositions flow faster and are thus easier to process and impregnation the fibrous material is faster and better. By reducing the melt viscosity of the polymer matrix, the limiting impregnation time needed to reach the desired degree of impregnation may be shortened, thereby increasing the overall manufacturing speed and thus leading to an increased productivity of the manufacture of the structures and to a decrease of energy consumption associated with a shorter cycle time which is beneficial also for environmental concerns.

FR 2,158,422 discloses a composite structure made of a low molecular weight polyamide matrix and reinforcing fibers. Due to the low molecular weight of the polyamide, the polyamide has low viscosity. The low viscosity of the polyamide matrix allows an efficient impregnation of the reinforcing fibers. Nevertheless, the use of low molecular weight polyamides may be associated with inferior mechanical properties of the composite structure.

U.S. Pat. No. 7,323,241 discloses a composite structure made of reinforcing fibers and a branched polyamide resin having a star structure. The disclosed polyamide having a star structure is said to exhibit a high fluidity in the molten state thus making possible a good impregnation of the reinforcing fibers so as to form a composite structure having good mechanical properties.

The existing technologies of using a highly flowable polyamide composition for improving or accelerating the impregnation of the fibrous material lead to composite structures that are not ideal for highly demanding applications such as for example in the automotive field. Indeed, there is a current and general desire in the automotive field for example to have high temperature resistant structures. Such high temperature resistant structures are required to retain their mechanical properties when they are exposed to temperatures higher than 120° C. or even higher than 200° C., such as those often reached in underhood areas of automobiles or to maintain their mechanical properties at an intermediate temperature, such as for example 90° C., for a long term exposure. When plastic parts are exposed to such combinations of time and temperature, it is a common phenomenon that the mechanical properties tend to decrease due to the thermo-oxidation of the polymer. This phenomenon is called heat aging.

Unfortunately, the existing technologies fail to combine an easy and efficient processability in terms of the impregnation rate of the fibrous material by a polymer, a good thermal resistance and a good retention of mechanical properties against long-term high temperature exposure.

There is a need for a composite structure comprising a fibrous material that can be easily, rapidly and efficiently impregnated with a matrix resin composition having a good melt rheology, which composite structure exhibits a good resistance against long-term high temperature exposure.

### SUMMARY OF THE INVENTION

It has been found that the above mentioned problems can be overcome by a composite structure having a surface, which surface has at least a portion made of a surface resin composition, and comprising a fibrous material selected from the group consisting of non-woven structures, textiles, fibrous battings and combinations thereof, said fibrous material being impregnated with a matrix resin composition, wherein the surface resin composition and the matrix resin composition is a polyamide composition comprising a) one or more polyamide resins selected from fully aliphatic polyamides and b) one or more polyhydric alcohols having more than two hydroxyl groups.

In a second aspect, the invention provides a process for making the composite structure. The process for making the composite structure described above comprises a step of i) impregnating the fibrous material with the matrix resin composition, wherein at least a portion of the surface of the composite structure is made of the surface resin composition.

### DETAILED DESCRIPTION

The composite structure according to the present invention exhibits a good heat resistance, a good retention of mechanical properties upon long-term high temperature exposure and can be manufactured in a efficient way and at a lower cost due to the optimum melt rheology of the matrix resin used to impregnate the fibrous material.

As used throughout the specification, the phrases “about” and “at or about” are intended to mean that the amount or value in question may be the value designated or some other value about the same. The phrase is intended to convey that similar values promote equivalent results or effects according to the invention.

As used herein, the term “high temperature long-term exposure” refers to a combination of exposure factors, i.e. time and temperature. Polymers which demonstrate heat aging performance under lab conditions or under conditions of the lifetime of the polymers such as those reached in underhood areas of automobiles (e.g. at a temperature at or in excess of 120° C., preferably at or in excess of 160° C., more preferably at or in excess of 180° C. and still more preferably at or in excess of 200° C. and the aging or exposure being at or in excess of 500 hours and preferably at or in excess of 1000 hours) can be shown to exhibit similar performance at lower temperatures for a much longer period of aging or exposure. The temperature dependence of the rate constants of polymer degradation is known from the literature such as for example in Journal of Materials Science, 1999, 34, 843-849, and is described by Arrhenius law; as an example aging at 180° C. for 500 hours is more-or-less equivalent to aging at 80° C. for 12 years.

The present invention relates to composite structures and processes to make them. The composite structure according to the present invention comprises a fibrous material that is impregnated with a matrix resin composition. At least a portion of the surface of the composite structure is made of a surface resin composition. The matrix resin composition and the surface resin composition may be the same or different.

As used herein, the term “a fibrous material being impregnated with a matrix resin composition” means that the matrix resin composition encapsulates and embeds the fibrous material so as to form an interpenetrating network of fibrous material substantially surrounded by the matrix resin composition. For purposes herein, the term “fiber” is defined as a macroscopically homogeneous body having a high ratio of length to width across its cross-sectional area perpendicular to its length. The fiber cross section can be any shape, but is typically round. The fibrous material may be in any suitable form known to those skilled in the art and is preferably selected from the group consisting of non-woven structures, textiles, fibrous battings and combinations thereof. Non-woven structures can be selected from random fiber orientation or aligned fibrous structures. Examples of random fiber orientation include without limitation chopped and continuous material which can be in the form of a mat, a needled mat or a felt. Examples of aligned fibrous structures include without limitation unidirectional fiber strands, bidirectional strands, multidirectional strands, multi-axial textiles. Textiles can be selected from woven forms, knits, braids and combinations thereof. The fibrous material can be continuous or discontinuous in form. Depending on the end-use application of the composite structure and the required mechanical properties, more than one fibrous materials can be used, either by using several same fibrous materials or a combination of different fibrous materials, i.e. the composite structure according to the present invention may comprise one or more fibrous materials. An example of a combination of different fibrous materials is a combination comprising a non-woven structure such as for example a planar random mat which is placed as a central layer and one or more woven continuous fibrous materials that are placed as outside layers. Such a combination allows an improvement of the processing and thereof of the homogeneity of the composite structure thus leading to improved mechanical properties. The fibrous material may be made of any suitable material or a mixture of materials provided that the material or the mixture of materials withstand the processing conditions used during impregnation by the matrix resin composition and the surface resin composition.

Preferably, the fibrous material comprises glass fibers, carbon fibers, aramid fibers, graphite fibers, metal fibers, ceramic fibers, natural fibers or mixtures thereof; more preferably, the fibrous material comprises glass fibers, carbon fibers, aramid fibers, natural fibers or mixtures thereof; and still more preferably, the fibrous material comprises glass fibers, carbon fibers and aramid fibers or mixture mixtures thereof. By natural fiber, it is meant any of material of plant origin or of animal origin. When used, the natural fibers are preferably derived from vegetable sources such as for example from seed hair (e.g. cotton), stem plants (e.g. hemp, flax, bamboo; both bast and core fibers), leaf plants (e.g. sisal and abaca), agricultural fibers (e.g., cereal straw, corn cobs, rice hulls and coconut hair) or lignocellulosic fiber (e.g. wood, wood fibers, wood flour, paper and wood-related materials). As mentioned above, more than one fibrous materials can be used. A combination of fibrous materials made of different fibers can be used such as for example a composite structure comprising one or more central layers made of glass fibers or natural fibers and one or more surface layers made of carbon fibers or glass fibers. Preferably, the fibrous material is selected from woven structures, non-woven structures or combinations thereof, wherein said structures are made of glass fibers and wherein the glass fibers are E-glass filaments with a diameter between 8 and 30 μm and preferably with a diameter between 10 to 24 μm.

The fibrous material may further contain a thermoplastic material and the materials described above, for example the fibrous material may be in the form of commingled or co-woven yarns or a fibrous material impregnated with a powder made of a thermoplastic material that is suited to subsequent processing into woven or non-woven forms, or a mixture for use as a uni-directional material.

Preferably, the ratio between the fibrous material and the polymer materials in the composite structure, i.e. the fibrous material in combination with the matrix resin composition and the surface resin composition, is at least 30% fibrous material and more preferably between 40 and 60% fibrous material, the percentage being a volume-percentage based on the total volume of the composite structure.

The surface resin composition and the matrix resin composition is a polyamide composition comprising a) one or more polyamide resins, and b) one or more polyhydric alcohols having more than two hydroxyl groups. Preferably, the one or more polyamide resins are selected from fully aliphatic polyamides. The surface resin composition and the matrix resin composition may be identical or different. When the surface resin composition and the matrix resin composition are different, it means that the component a), i.e. the one or more polyamide resins, and/or the component b), i.e. the one or more polyhydric alcohols having more than two hydroxyl groups, are not the same and/or that the amounts of component a) and b) are different in the surface resin composition and the matrix resin composition. Polyamide resins are condensation products of one or more dicarboxylic acids and one or more diamines, and/or one or more aminocarboxylic acids, and/or ring-opening polymerization products of one or more cyclic lactams. The term “semi-aromatic” describes polyamide resins that comprise at least some aromatic carboxylic acid monomer(s) and aliphatic diamine monomer(s), in comparison with “fully aliphatic” which describes polyamide resins comprising aliphatic carboxylic acid monomer(s) and aliphatic diamine monomer(s).

Fully aliphatic polyamide resins are formed from aliphatic and alicyclic monomers such as diamines, dicarboxylic acids, lactams, aminocarboxylic acids, and their reactive equivalents. A suitable aminocarboxylic acid includes 11-aminododecanoic acid. In the context of this invention, the term “fully aliphatic polyamide resin” also refers to copolymers derived from two or more such monomers and blends of two or more fully aliphatic polyamide resins. Linear, branched, and cyclic monomers may be used.

Carboxylic acid monomers comprised in fully aliphatic polyamide resins include, but are not limited to, aliphatic carboxylic acids, such as for example adipic acid (C6), pimelic acid (C7), suberic acid (C8), azelaic acid (C9), sebacic acid (C10), dodecanedioic acid (C12) and tetradecanedioic acid (C14). Diamines can be chosen among diamines having four or more carbon atoms, including, but not limited to tetramethylene diamine, hexamethylene diamine, octamethylene diamine, decamethylene diamine, 2-methylpentamethylene diamine, 2-ethyltetramethylene diamine, 2-methyloctamethylene diamine; trimethylhexamethylene diamine and/or mixtures thereof. Suitable examples of fully aliphatic polyamide resins include PA6; PA6,6; PA4,6; PA6,10; PA6,12; PA6,14; P 6,13; PA 6,15; PA6,16; PA11; PA 12; PA10; PA9,12; PA9,13; PA9,14; PA9,15; P 6,16; PA9,36; PA10,10; PA10,12; PA10,13; PA10,14; PA12,10; PA12,12; PA12, 13; 12,14 and copolymers and blends of the same. Preferred examples of fully aliphatic polyamide resins comprised in the polyamide composition described herein include PA6, PA11, PA12, PA4,6, PA6,6, PA,10; PA6,12; PA10,10 and copolymers and blends of the same.

The polyamide compositions may further comprise one or more semi-aromatic polyamides. Semi-aromatic polyamide resins are homopolymers, copolymers, terpolymers, or higher polymers wherein at least a portion of the acid monomers are selected from one or more aromatic carboxylic acids. The one or more aromatic carboxylic acids can be terephthalic acid or mixtures of terephthalic acid and one or more other carboxylic acids, like isophthalic acid, substituted phthalic acid such as for example 2-methylterephthalic acid and unsubstituted or substituted isomers of naphthalenedicarboxylic acid, wherein the carboxylic acid component preferably contains at least 55 mole-% of terephthalic acid (the mole-% being based on the carboxylic acid mixture). Preferably, the one or more aromatic carboxylic acids are selected from the group consisting of terephthalic acid, isophthalic acid and mixtures thereof and more preferably, the one or more carboxylic acids are mixtures of terephthalic acid and isophthalic acid, wherein the mixture preferably contains at least 55 mole-% of terephthalic acid. Furthermore, the one or more carboxylic acids can be mixed with one or more aliphatic carboxylic acids, like adipic acid; pimelic acid; suberic acid; azelaic acid; sebacic acid and dodecanedioic acid, adipic acid being preferred. More preferably the mixture of terephthalic acid and adipic acid comprised in the one or more carboxylic acids mixtures of the semi-aromatic polyamide resin contains at least 25 mole-% of terephthalic acid. Semi-aromatic polyamide resins comprise one or more diamines that can be chosen among diamines having four or more carbon atoms, including, but not limited to tetramethylene diamine, hexamethylene diamine, octamethylene diamine, nonamethylene diamine, decamethylene diamine, 2-methylpentamethylene diamine, 2-ethyltetramethylene diamine, 2-methyloctamethylene diamine; trimethylhexamethylene diamine, bis(p-aminocyclohexyl)methane; m-xylylene diamine; p-xylylene diamine and/or mixtures thereof. Suitable examples of semi-aromatic polyamide resins include poly(hexamethylene terephthalamide) (polyamide 6,T), poly(nonamethylene terephthalamide) (polyamide 9,T), poly(decamethylene terephthalamide) (polyamide 10,T), poly(dodecamethylene terephthalamide) (polyamide 12,T), hexamethylene adipamide/hexamethylene terephthalamide copolyamide (polyamide 6,T16,6), hexamethylene terephthalamide/hexamethylene isophthalamide (6,T/6,I), poly(m-xylylene adipamide) (polyamide MXD,6), hexamethylene adipamide/hexamethylene terephthalamide copolyamide (polyamide 6,T/6,6), hexamethylene terephthalamide/2-methylpentamethylene terephthalamide copolyamide (polyamide 6,T/D,T), hexamethylene adipamide/hexamethylene terephthalamide/hexamethylene isophthalamide copolyamide (polyamide 6,6/6,T/6,I); poly(caprolactam-hexamethylene terephthalamide) (polyamide 6/6,T) and copolymers and blends of the same. Preferred examples of semi-aromatic polyamide resins include PA6,T; PA6,T/6,6, PA6,T/6,1; PAMXD,6; PA6,T/D,T and copolymers and blends of the same.

The matrix resin composition and the surface resin composition are selected from polyamide compositions comprising one or more polyhydric alcohols having more than two hydroxyl groups. Preferably, the one or more polyhydric alcohols are present in the polyamide compositions described herein independently in an amount from at or about 0.25 wt-% to at or about 15 wt-%, more preferably from at or about 0.5 wt-% to at or about 10 wt-% and still more preferably from 0.5 wt-% to at or about 5 wt-%, the weight percentages being based on the total weight of the polyamide composition.

The one or more polyhydric alcohols may be independently selected from aliphatic hydroxylic compounds containing more than two hydroxyl groups, aliphatic-cycloaliphatic compounds containing more than two hydroxyl groups, cycloaliphatic compounds containing more than two hydroxyl groups, and saccharides having more two hydroxyl groups. An aliphatic chain in the polyhydric alcohol can include not only carbon atoms but also one or more hetero atoms which may be selected, for example, from nitrogen, oxygen and sulphur atoms. A cycloaliphatic ring present in the polyhydric alcohol can be monocyclic or part of a bicyclic or polycyclic ring system and may be carbocyclic or heterocyclic. A heterocyclic ring present in the polyhydric alcohol can be monocyclic or part of a bicyclic or polycyclic ring system and may include one or more hetero atoms which may be selected, for example, from nitrogen, oxygen and sulphur atoms. The one or more polyhydric alcohols may contain one or more substituents, such as ether, carboxylic acid, carboxylic acid amide or carboxylic acid ester groups.

Examples of polyhydric alcohol containing more than two hydroxyl groups include, without limitation, triols, such as glycerol, trimethylolpropane, 2,3-di-(2′-hydroxyethyl)-cyclohexan-1-ol, hexane-1,2,6-triol, 1,1,1-tris-(hydroxymethyl)ethane, 3-(2′-hydroxyethoxy)-propane-1,2-diol, 3-(2′-hydroxypropoxy)-propane-1,2-diol, 2-(2′-hydroxyethoxy)-hexane-1,2-diol, 6-(2′-hydroxypropoxy)-hexane-1,2-diol, 1,1,1-tris-[(2′-hydroxyethoxy)-methyl]-ethane, 1,1,1-tris-[(2′-hydroxypropoxy)-methyl]-propane, 1,1,1-tris-(4′-hydroxyphenyl)-ethane, 1,1,1-tris-(hydroxyphenyl)-propane, 1,1,3-tris-(dihydroxy-3-methylphenyl)-propane, 1,1,4-tris-(dihydroxyphenyl)-butane, 1,1,5-tris-(hydroxyphenyl)-3-methylpentane, di-trimethylopropane, trimethylolpropane ethoxylates, or trimethylolpropane propoxylates; polyols such as pentaerythritol, dipentaerythritol, and tripentaerythritol; and saccharides having more two hydroxyl groups, such as cyclodextrin, D-mannose, glucose, galactose, sucrose, fructose, xylose, arabinose, D-mannitol, D-sorbitol, D- or arabitol, xylitol, iditol, talitol, allitol, altritol, guilitol, erythritol, threitol, and D-gulonic-y-lactone and the like.

Preferred polyhydric alcohols include those having a pair of hydroxyl groups which are attached to respective carbon atoms which are separated one from another by at least one atom. Especially preferred polyhydric alcohols are those in which a pair of hydroxyl groups is attached to respective carbon atoms which are separated one from another by a single carbon atom.

Preferably, the one or more polyhydric alcohols comprised in the polyamide composition described herein are independently selected from the group consisting of pentaerythritol, dipentaerythritol, tripentaerythritol, di-trimethylopropane, D-mannitol, D-sorbitol, xylitol and mixtures thereof. More preferably, the one or more polyhydric alcohols comprised in the polyamide composition described herein are independently selected from the group consisting of dipentaerythritol, tripentaerythritol, pentaerythritol and mixtures thereof. Still more preferably, the one or more polyhydric alcohols comprised in the polyamide composition described herein are dipentaerythritol and/or pentaerythritol.

The surface resin composition and/or the matrix resin composition may further comprise one or more impact modifiers, one or more heat stabilizers, one or more oxidative stabilizers, one or more reinforcing agents, one or more ultraviolet light stabilizers, one or more flame retardant agents or mixtures thereof.

Preferred impact modifiers include those typically used for polyamide compositions, including carboxyl-substituted polyolefins, ionomers and/or mixtures thereof. Carboxyl-substituted polyolefins are polyolefins that have carboxylic moieties attached thereto, either on the polyolefin backbone itself or on side chains. By “carboxylic moieties” it is meant carboxylic groups such as one or more of dicarboxylic acids, diesters, dicarboxylic monoesters, acid anhydrides, and monocarboxylic acids and esters. Useful impact modifiers include dicarboxyl-substituted polyolefins, which are polyolefins that have dicarboxylic moieties attached thereto, either on the polyolefin backbone itself or on side chains. By “dicarboxylic moiety” it is meant dicarboxylic groups such as one or more of dicarboxylic acids, diesters, dicarboxylic monoesters, and acid anhydrides. The impact modifier may be based on an ethylene/alpha-olefin polyolefin such as for example ethylene/octene. Diene monomers such as 1,4-butadiene; 1,4-hexadiene; or dicyclopentadiene may optionally be used in the preparation of the polyolefin. Preferred polyolefins include ethylene-propylene-diene (EPDM) and styrene-ethylene-butadiene-styrene (SEBS) polymers. More preferred polyolefins include ethylene-propylene-diene (EPDM), wherein the term “EPDM” means a terpolymer of ethylene, an alpha olefin having from three to ten carbon atoms, and a copolymerizable non-conjugated diene such as 5-ethylidene-2-norbornene, dicyclopentadiene, 1,4-hexadiene, and the like. As will be understood by those skilled in the art, the impact modifier may or may not have one or more carboxyl moieties attached thereto. The carboxyl moiety may be introduced during the preparation of the polyolefin by copolymerizing with an unsaturated carboxyl-containing monomer. Preferred is a copolymer of ethylene and maleic anhydride monoethyl ester. The carboxyl moiety may also be introduced by grafting the polyolefin with an unsaturated compound containing a carboxyl moiety, such as an acid, ester, diacid, diester, acid ester, or anhydride. A preferred grafting agent is maleic anhydride. Blends of polyolefins, such as polyethylene, polypropylene, and EPDM polymers with polyolefins that have been grafted with an unsaturated compound containing a carboxyl moiety may be used as an impact modifier. The impact modifier may be based on ionomers. By “ionomer”, it is meant a carboxyl group containing polymer that has been neutralized or partially neutralized with metal cations such as zinc, sodium, or lithium and the like. Examples of ionomers are described in U.S. Pat. Nos. 3,264,272 and 4,187,358. Examples of suitable carboxyl group containing polymers include, but are not limited to, ethylene/acrylic acid copolymers and ethylene/methacrylic acid copolymers. The carboxyl group containing polymers may also be derived from one or more additional monomers, such as, but not limited to, butyl acrylate. Zinc salts are preferred neutralizing agents. Ionomers are commercially available under the trademark Surlyn® from E.I. du Pont de Nemours and Co., Wilmington, Del. When present, the one or more impact modifiers comprise up to at or about 30 wt-%, or preferably from at or about 3 to at or about 25 wt-%, or more preferably from at or about 5 to at or about 20 wt-%, the weight percentage being based on the total weight of the surface resin composition or the matrix resin composition, as the case may be.

The surface resin composition and/or the matrix resin composition may further comprise one or more heat stabilizers. The one or more heat stabilizers are preferably selected from the group consisting of copper salts and/or derivatives thereof, hindered amine antioxidants, phosphorus antioxidants and mixtures thereof and more preferably from copper salts and/or derivatives combined with a halide compound, from hindered phenol antioxidants, hindered amine antioxidants, phosphorus antioxidants and mixtures thereof. Examples of copper salts and/or derivatives thereof include without limitation copper halides or copper acetates; divalent manganese salts and/or derivatives thereof and mixtures thereof. Preferably, copper salts and/or derivatives are used in combination with halide compounds and/or phosphorus compounds and more preferably copper salts are used in combination with iodide or bromide compounds, and still more preferably, with potassium iodide or potassium bromide. When present, the one or more heat stabilizers are present in an amount from at or about 0.1 to at or about 3 wt-%, or preferably from at or about 0.1 to at or about 1 wt-%, or more preferably from at or about 0.1 to at or about 0.7 wt-%, the weight percentage being based on the total weight of the surface resin composition or the matrix resin composition, as the case may be. The addition of the one or more heat stabilizers further improves the thermal stability of the composite structure during its manufacture (i.e. a decreased molecular weight reduction is obtained) as well as its thermal stability upon use and time. In addition to the improved heat stability, the presence of the one or more heat stabilizers may allow an increase of the temperature that is used during the impregnation of the composite structure, thus reducing the melt viscosity of the matrix resin and/or the polyamide composition described herein. As a consequence of a reduced melt viscosity of the matrix resin and/or the polyamide surface resin composition, impregnation rate may be increased.

The surface resin composition and/or the matrix resin composition may further contain one or more oxidative stabilizers such as for example phosphorus antioxidants (e.g. phosphite or phosphonite stabilizers), hindered phenol stabilizers, aromatic amine stabilizers, thioesters, and phenolic based anti-oxidants that hinder thermally induced oxidation of polymers where high temperature applications are used. When present, the one or more oxidative stabilizers comprise from at or about 0.1 to at or about 3 wt-%, or preferably from at or about 0.1 to at or about 1 wt-%, or more preferably from at or about 0.1 to at or about 0.7 wt-%, the weight percentage being based on the total weight of the surface resin composition or the matrix resin composition, as the case may be.

The surface resin composition and/or the matrix resin composition may further contain one or more reinforcing agents such as glass fibers, glass flakes, carbon fibers, mica, wollastonite, calcium carbonate, talc, calcined clay, kaolin, magnesium sulfate, magnesium silicate, barium sulfate, titanium dioxide, sodium aluminum carbonate, barium ferrite, and potassium titanate. When present, the one or more reinforcing agents are present in an amount from at or about 1 to at or about 60 wt-%, preferably from at or about 1 to at or about 40 wt-%, or more preferably from at or about 1 to at or about 35 wt-%, the weight percentages being based on the total weight of the surface resin composition or the matrix resin composition, as the case may be.

The surface resin composition and/or the matrix resin composition may further contain one or more ultraviolet light stabilizers such as hindered amine light stabilizers (HALS), carbon black, substituted resorcinols, salicylates, benzotriazoles, and benzophenones.

The surface resin composition and/or the matrix resin composition may further contain one or more flame retardant agents such as metal oxides (wherein the metal may be aluminum, iron, titanium, manganese, magnesium, zirconium, zinc, molybdenum, cobalt, bismuth, chromium, tin, antimony, nickel, copper and tungsten), metal powders (wherein the metal may be aluminum, iron, titanium, manganese, zinc, molybdenum, cobalt, bismuth, chromium, tin, antimony, nickel, copper and tungsten), metal salts such as zinc borate, zinc metaborate, barium metaborate, zinc carbonate, magnesium carbonate, calcium carbonate and barium carbonate, metal phosphinates (wherein the metal may be aluminum, zinc and calcium), halogenated organic compounds like decabromodiphenyl ether, halogenated polymer such as poly(bromostyrene) and brominated polystyrene, melamine pyrophosphate, melamine cyanurate, melamine polyphosphate, red phosphorus, and the like.

With the aim of further reducing the melt viscosity of the matrix resin composition, the matrix resin composition described herein may further comprise one or more rheology modifiers selected from the group consisting of hyperbranched polymers (also known as dendritic or highly branched polymers, dendritic macromolecules or arborescent polymers), molecular chain breaking agents and mixtures thereof. Hyperbranched polymers are three dimensional highly branched molecules having a treelike structure. Hyperbranched polymers are macromolecules that comprise one or more branching comonomer units. The branching units comprise branching layers and optionally a nucleus (also known as core), one or more spacing layers and/or a layer of chain terminating molecules. Continued replication of the branching layers yields increased branch multiplicity, branch density, and an increased number of terminal functional groups compared to other molecules. Preferred hyperbranched polymers include hyperbranched polyesters. Preferred examples of hyperbranched polymers are those described in U.S. Pat. No. 5,418,301 US 2007/0173617. The use of such hyperbranched polymers in thermoplastic resins is disclosed in U.S. Pat. No. 6,225,404, U.S. Pat. No. 6,497,959, U.S. Pat. No. 6,663,966, WO 2003/004546, EP 1424360 and WO 2004/111126. This literature teaches that the addition of hyperbranched polymeric polyester macromolecules to thermoplastic compositions leads to improved rheological and mechanical properties due to the reduction of the melt viscosity of the composition and, therefore, leads to an improved processability of the thermoplastic composition. When present, the one or more hyperbranched polymers comprise from at or about 0.05 to at or about 10 wt-%, or more preferably from at or about 0.1 to at or about 5 wt-%, the weight percentage being based on the total weight of the matrix resin composition. Examples of molecular chain breaking agents include without limitation aliphatic dicarboxylic acids and aromatic dicarboxylic acids. Specific examples thereof are oxalic acid, malonic acid, succinic acid, adipic acid, azelaic acid, sebacic acid, dodecanedioic acid and isomers of phthalic acid. When present, the one or more molecular chain breaking agents comprise from at or about 0.05 to at or about 5 wt-%, or more preferably from at or about 0.1 to at or about 3 wt-%, the weight percentage being based on the total weight of the matrix resin composition.

The surface resin composition and/or the matrix resin composition may further include modifiers and other ingredients, including, without limitation, flow enhancing additives, lubricants, antistatic agents, coloring agents (including dyes, pigments, carbon black, and the like), flame retardants, nucleating agents, crystallization promoting agents and other processing aids known in the polymer compounding art.

Fillers, modifiers and other ingredients described above may be present in amounts and in forms well known in the art, including in the form of so-called nano-materials where at least one of the dimensions of the particles is in the range of 1 to 1000 nm.

A preferred surface resin composition and/or matrix resin composition is the following polyamide composition: a polyamide composition comprising a) a polyamide resin, preferably a polyamide copolymer made of adipic acid and 1,6-hexamethylenediamine (PA6,6), and b) from at or about 0.5 wt-% to at or about 5 wt-% of dipentaerythritol, the weight percentages being based on the total weight of the polyamide composition. This composition may further comprise one or more heat stabilizers, preferably the one or more heat stabilizers are selected from copper salts combined with a halide compound and more preferably copper iodide combined with potassium iodide. When present, the one or more heat stabilizers are present in an amount from at or about 0.1 to at or about 0.7 wt-%, the weight percentages being based on the total weight of the polyamide composition.

Preferably, the surface resin composition and/or the matrix resin composition are melt-mixed blends, wherein all of the polymeric components are well-dispersed within each other and all of the non-polymeric ingredients are well-dispersed in and bound by the polymer matrix, such that the blend forms a unified whole. Any melt-mixing method may be used to combine the polymeric components and non-polymeric ingredients of the present invention. For example, the polymeric components and non-polymeric ingredients may be added to a melt mixer, such as, for example, a single or twin-screw extruder; a blender; a single or twin-screw kneader; or a Banbury mixer, either all at once through a single step addition, or in a stepwise fashion, and then melt-mixed. When adding the polymeric components and non-polymeric ingredients in a stepwise fashion, part of the polymeric components and/or non-polymeric ingredients are first added and melt-mixed with the remaining polymeric components and non-polymeric ingredients being subsequently added and further melt-mixed until a well-mixed composition is obtained.

Depending on the end-use application, the composite structure according to the present invention may have any shape. In a preferred to embodiment, the composite structure according to the present invention is in the form of a sheet structure. The first component may be flexible, in which case it can be rolled.

In another aspect, the present invention relates to a process for making the composite structures described above and the composite structures obtained thereof. The process for making a composite structure having a surface comprises a step of i) impregnating the fibrous material with the matrix resin composition, wherein at least a portion of the surface of the composite structure is made of the surface resin composition. Preferably, the fibrous material is impregnated with the matrix resin by thermopressing. During thermopressing, the fibrous material, the matrix resin composition and the surface resin composition undergo heat and pressure in order to allow the resin compositions to melt and penetrate through the fibrous material and, therefore, to impregnate said fibrous material. Typically, thermopressing is made at a pressure between 2 and 100 bars and more preferably between 10 and 40 bars and a temperature which is above the melting point of the matrix resin composition and the surface resin composition, preferably at least about 20° C. above the melting point to enable a proper impregnation. Heating may be done by a variety of means, including contact heating, radiant gas heating, infra red heating, convection or forced convection air heating, induction heating, microwave heating or combinations thereof.

Due to the improved heat stability obtained by adding the one or more polyhydric alcohols having more than two hydroxyl groups in the polyamide composition, the temperature that is used during the impregnation of the composite structure can be increased relative to a polyamide resin without a polyhydric alcohol having more than two hydroxyl groups. The reduced melt viscosity of the matrix resin obtained by this increase of temperature allows to decrease the impregnation time, thus improving the overall manufacturing rate of the composite structure.

The impregnation pressure can be applied by a static process or by a continuous process (also known as dynamic process), a continuous process being preferred for reasons of speed. Examples of impregnation processes include without limitation vacuum molding, in-mold coating, cross-die extrusion, pultrusion, wire coating type processes, lamination, stamping, diaphragm forming or press-molding, lamination being preferred. During lamination, heat and pressure are applied to the fibrous material, the matrix resin composition and the surface resin composition is through opposing pressured rollers or belts in a heating zone, preferably followed by the continued application of pressure in a cooling zone to finalize consolidation and cool the impregnated fibrous material by pressurized means. Examples of lamination techniques include without Urination calendering, flatbed lamination and double-belt press lamination. When lamination is used as the impregnating process, preferably a double-belt press is used for lamination.

The matrix resin composition and the surface resin composition are applied to the fibrous material by conventional means such as for example powder coating, film lamination, extrusion coating or a combination of two or more thereof, provided that the surface resin composition is applied on at least a portion of the surface of the composite structure, which surface is exposed to the environment of the composite structure.

During a powder coating process, a polymer powder which has been obtained by conventional grinding methods is applied to the fibrous material. The powder may be applied onto the fibrous material by scattering, sprinkling, spraying, thermal or flame spraying, or fluidized bed coating methods. Optionally, the powder coating process may further comprise a step which consists in a post sintering step of the powder on the fibrous material. The matrix resin composition and the surface resin composition are applied to the fibrous material such that at least a portion of the surface of the composite structure is made of the surface resin composition. Subsequently, thermopressing is performed on the powder coated fibrous material, with an optional preheating of the powder coated fibrous material outside of the pressurized zone.

During film lamination, one or more films made of the matrix resin composition and one or more films made of the surface resin to composition which have been obtained by conventional extrusion methods known in the art such as for example blow film extrusion, cast film extrusion and cast sheet extrusion are applied to the fibrous material, e.g. by layering. Subsequently, thermopressing is performed on the assembly comprising the one or more films made of the matrix resin composition and the one or more films made of the surface resin composition and the one or more fibrous materials. In the resulting composite structure, the films melt and penetrate around the fibrous material as a polymer continuum surrounding the fibrous material. During extrusion coating, pellets and/or granulates made of the matrix resin composition and pellets and/or granulates made of the surface resin composition are melted and extruded through one or more flat dies so as to form one or more melt curtains which are then applied onto the fibrous material by laying down the one or more melt curtains. Subsequently, thermopressing is performed on the assembly comprising the matrix resin composition, the surface resin composition and the one or more fibrous materials.

Depending on the end-use application, the composite structure obtained under step i) may be shaped into a desired geometry or configuration, or used in sheet form. The process for making a composite structure according to the present invention may further comprises a step ii) of shaping the composite structure, said step arising after the impregnating step i). The step of shaping the composite structure obtained under step i) may be done by compression molding, stamping, direct forming in an injection molding machine, or any technique using heat and/or pressure. Preferably, pressure is applied by using a hydraulic molding press. During compression molding or stamping, the composite structure is preheated to a temperature above the melt temperature of the surface resin composition by heated means and is transferred to a forming or shaping means such as a molding press containing a mold having a cavity of the shape of the final desired geometry whereby it is shaped into a desired configuration and is thereafter removed from the press or the mold after cooling to a temperature below the melt temperature of the surface resin composition and preferably below the melt temperature the matrix resin composition.

According to another embodiment, the invention provides a method for improving the resistance against long-term high temperature exposure of a composite structure. This method comprises a step of blending a) one or more polyamide resins and b) one or more polyhydric alcohols having more than two hydroxyl groups so as to form the polyamide compositions described herein and impregnating the fibrous material described herein with a matrix resin composition selected from the polyamide compositions so as to form a composite structure having a surface, which surface has at least a portion made of the surface resin composition described herein.

According to another embodiment, the invention provides a use of the composite structures described herein for high temperature applications.

The composite structures according to the present invention may be used in a wide variety of applications such as for example as components for automobiles, trucks, commercial airplanes, aerospace, rail, household appliances, computer hardware, hand held devices, recreation and sports, structural component for machines, structural components for buildings, structural components for photovoltaic or wind energy equipments or structural components for mechanical devices.

Examples of automotive applications include without limitation seating components and seating frames, engine cover brackets, engine cradles, suspension arms and cradles, spare tire wells, chassis reinforcement, floor pans, front-end modules, steering column frames, instrument panels, door systems, body panels (such as horizontal body panels and door panels), tailgates, hardtop frame structures, convertible top frame structures, roofing structures, engine covers, housings for transmission and power delivery components, oil pans, airbag housing canisters, automotive interior impact structures, engine support brackets, cross car beams, bumper beams, pedestrian safety beams, firewalls, rear parcel shelves, cross vehicle bulkheads, pressure vessels such as refrigerant bottles and fire extinguishers and truck compressed air brake system vessels, hybrid internal combustion/electric or electric vehicle battery trays, automotive suspension wishbone and control arms, suspension stabilizer links, leaf springs, vehicle wheels, recreational vehicle and motorcycle swing arms, fenders, roofing frames and tank flaps.

Examples of household appliances include without limitation washers, dryers, refrigerators, air conditioning and heating. Examples of recreation and sports include without limitation inline-skate components, baseball bats, hockey sticks, ski and snowboard bindings, rucksack backs and frames, and bicycle frames. Examples of structural components for machines include electrical/electronic parts such as for example housings for hand held electronic devices, computers.

### EXAMPLES

The following materials were used for preparing the composites structures according to the present invention and comparative examples.

### Materials

The materials below make up the compositions used in the Examples and Comparative Examples.

Polyamide 1: polyamide made of adipic acid and 1,6-hexamethylenediamine with a weight average molecular weight of around 32000 Daltons. This polymer is called PA6,6 and is commercially available, for example, from E.I. du Pont de Nemours and Company.
Polyhydric alcohol: dipentaerythritol commercially available from Perstorp Speciality Chemicals AB, Perstorp, Sweden as Di-Penta 93.

### Preparation of Films

Compositions listed in Table 1 were prepared by melt blending the ingredients in a 58 mm twin screw extruder operating at about 280° C. barrel setting, about 350 rpm, a throughput of 295 kg/hour. Upon exiting the extruder, the compositions were cooled and pelletized. The compounded mixtures was extruded in the form of laces or strands, cooled in a water bath, chopped into granules and placed into sealed aluminum to lined bags in order to prevent moisture pick up. The cooling and cutting conditions were adjusted to ensure that the materials were kept below 0.2% of moisture level.

Compositions listed in Table 1 were cast into about 100 micron films using a twin screw extruder equipped with a 80 inch wide film die and a casting roll. The films were processed at about 90-95 feet per minute line speed and about 400-450 kg/hour throughput with a melt temperature of about 280° C. and cast roll temperature at about 60° C.

### Preparation of the Composite Structures

The composite structures C1 and E1 were prepared by stacking 8 layers made of the compositions listed in Table 1 and 3 layers of woven continuous glass fiber textile (E-glass fibers having a diameter of 17 microns, 0.4% of a silane-based sizing and a nominal roving tex of 1200 g/km that have been woven into a 2/2 twill (balanced weave) with an areal weight of 600 g/m²) in the following sequence: two layers of layers made of the compositions listed in Table 1, one layer of woven continuous glass fiber textile, two layers of layers made of the compositions listed in Table 1, one layer of woven continuous glass fiber textile, two layers of layers made of the compositions listed in Table 1, one layer of woven continuous glass fiber textile and two layers made of the compositions listed in Table 1. The composite structures listed in Table 1 had an overall thickness of about 1.5 mm.

The composite structures were prepared using an isobaric double press machine with counter rotating steel belts, both supplied by Held GmbH. The different films enterered the machine from unwinders in the previously defined stacking sequence. The heating zones were about 2000 mm long and the cooling zones were about 1000 mm long. Heating and cooling were maintained without release of pressure. The composite structures were prepared with the following conditions:

lamination rate: 1 m/min,
maximum machine temperature: 360° C., and
laminate pressure: 40 bar.

### Physical Properties

Melt viscosity. Prior to melt viscosity measurement, the granules of the compositions listed in Table 1 were dried at 100° C. for 6 hours in a vacuum dryer so as to have a moisture level below 0.2 percent. Melt viscosity was measured according to ISO 11443 at a shear rate of 1000 s⁻¹ and 290° C. A KAYENESS Capillary Rheometer (Dynisco, Mass.) and a capillary die of 0.04 inch diameter and L/D of 15 were used for viscosity measurement. Melt viscosity was measured 5 minutes (=hold up time (HUT)) after the compositions had been introduced into the rheometer barrel. The average values of melt viscosity obtained from 5 specimens are given in Table 1.
Flexural strength. Flexural strength refers to the ratio of applied force needed to bend the sample to the sample cross sectional area and is commonly used as an indication of a material's ability to bear (or to sustain) load when flexed.

The composite structures listed in Table 1 (C1-C2 and E1-E2) were cut with a CNC water jet cutter into test specimens having the shape of about 20 mm×about 60 mm rectangular bars and flexural strength was measured.

Flexural testing was performed according to ISO 178 with the following conditions: test speed of 20 mm/min, span length (L) of 23 mm, radius of loading edge (R₁) of 5 mm+/−0.1 mm, radius of support (R₂) of 2 mm+/−0.2 mm, preload of 10 N, and preload speed of 10 mm/min.

The test specimens were heat aged in re-circulating air ovens at 210° C. according to the procedure detailed in ISO 2578. Flexural testing was then performed according to ISO 178. At various heat aging times, the test specimens were removed from the oven, allowed to cool to room temperature and sealed into aluminum lined bags until ready for testing. The average values obtained from 5 specimens are given in Table 1. Retention of flexural strength corresponds to the percentage of the flexural strength after heat aging for 255 hours or 500 hours in comparison with the value of the specimens non-heat-aged considered as being 100%. Retention results are given in Table 1.

TABLE 1

| | C1 | E1 |
|---|---|---|
| polymer | PA6, 6 | PA6, 6 |
| DPE | — | 1.5 |
| Viscosity | 70 | 55 |
| Flexural strength | | |
| non-heat aged/MPa | 685 (6) | 618 (30) |
| heat aged for 255 hours/MPa | 612 (68) | 694 (73) |
| retention % | 89 | 112 |
| heat aged for 500 hours/MPa | 111 (8) | 197 (38) |
| retention % | 16 | 32 |

Values in ( ) refer to standard deviation values.

Table 1 shows that compositions comprising an aliphatic polyamide and a polyhydric alcohol exhibited a lower melt viscosity compared with that of the compositions comprising only the polyamide polymers. Such lower melt viscosities indicate that the incorporation of a polyhydric alcohol improves the melt rheology behavior of the polyamide composition. As mentioned above, by having a melt viscosity as low as possible, polyamide compositions impregnated faster and were thus easier to process.

As shown in Table 1, the composites structures according to the to present invention (E1), i.e. composite structures, wherein the surface resin compostion and the matrix resin composition comprised a polyamide resin and a polyhydric alcohol having more than two hydroxyl groups, retained flexural strength after heat aging while the comparative examples composite structures C1 and C2 had reductions in flexural strength.

What is claimed is:

1. A composite structure having a surface, which surface has at least a portion made of a surface resin composition, and comprising a fibrous material selected from the group consisting of non-woven structures, textiles, fibrous battings and combinations thereof, said fibrous material being impregnated with a matrix resin composition, wherein the surface resin composition and the matrix resin composition is a polyamide composition comprising:
a) one or more polyamide resins selected from fully aliphatic polyamides, and
b) one or more polyhydric alcohols having more than two hydroxyl groups.

2. The composite structure of claim 1, wherein the one or more polyhydric alcohols are present in the polyamide compositions independently in an amount from at or about 0.25 wt-% to at or about 15 wt-%, the weight percentage being based on the total weight of the polyamide composition.

3. The composite structure of claim 1, wherein the one or more polyhydric alcohols are present independently in an amount from at or about 0.5 wt-% to at or about 10 wt-%, the weight percentage being based on the total weight of the polyamide composition.

4. The composite structure of claim 1, wherein the one or more polyhydric alcohols are independently selected from the group consisting of dipentaerythritol, tripentaerythritol, pentaerythritol and mixtures thereof.

5. The composite structure of claim 1, wherein the fully aliphatic polyamide resins are independently selected from the group consisting of PA6; PA11; PA12; PA4,6; PA6,6; PA,10; PA6,12; PA10,10 and copolymers and blends of the same.

6. The composite structure of claim 1, wherein the fibrous material comprises glass fibers, carbon fibers, aramid fibers, natural fibers or mixtures thereof.

7. The composite structure of claim 1, wherein the fibrous material comprises glass fibers.

8. The composite structure of claim 1, wherein the surface resin composition, or the matrix resin composition, or both further comprise one or more impact modifiers, one or more heat stabilizers, one or more oxidative stabilizers, one or more reinforcing agents, one or more ultraviolet light stabilizers, one or more flame retardant agents or mixtures thereof.

9. The composite structure according of claim 1 in the form of components for automobiles, trucks, commercial airplanes, aerospace, rail, household appliances, computer hardware, hand held devices, recreation and sports, structural component for machines, structural components for buildings, structural components for photovoltaic or wind energy equipments or structural components for mechanical devices.

10. A process for making a composite structure having a surface, said process comprises a step of:
i) impregnating a fibrous material with a matrix resin composition,
wherein the fibrous material is selected from the group consisting of non-woven structures, textiles, fibrous battings and combinations thereof,
wherein at least a portion of the surface of the composite structure is made of a surface resin composition, and
wherein the surface resin composition and the matrix resin composition is a polyamide composition comprising a) one or more polyamide resins selected from fully aliphatic polyamides and b) one or more polyhydric alcohols having more than two hydroxyl groups.

11. The process of claim 10, wherein the one or more polyhydric alcohols are present in the polyamide compositions independently in an amount from at or about 0.25 wt-% to at or about 15 wt-%, the weight percentage being based on the total weight of the polyamide composition.

12. The process of claim 10, wherein the one or more polyhydric alcohols are independently selected from the group consisting of dipentaerythritol, tripentaerythritol, pentaerythritol and mixtures thereof.

13. The process of claim 10, wherein the fibrous material comprises glass fibers, carbon fibers, aramid fibers, natural fibers or mixtures thereof.

14. The process of claim 10, wherein the impregnation is carried out by vacuum molding, in-mold coating, cross-die extrusion, pultrusion, to wire coating type processes, lamination, stamping, diaphragm forming or press-molding.

15. The process of claim 10, further comprising a step of shaping the composite structure, said step of shaping arising after the step of impregnating.
